(19) United States
(12) Patent Application Publication
(10) Pub. No.: US 2026/0288870 A1
(43) Pub. Date: Sep. 24, 2026

(54) METHOD AND APPARATUS FOR EDITING NODE-EDGE GRAPH, DEVICE AND MEDIUM

(71) Applicant: Beijing Zitiao Network Technology Co., Ltd., Beijing (CN)

(72) Inventors: Chenyun Zeng, Beijing (CN); Shengfan He, Beijing (CN)

(21) Appl. No.: 19/572,117

(22) Filed: Mar. 19, 2026

(30) Foreign Application Priority Data
Mar. 19, 2025 (WO) PCT/CN2025/083581

(51) Int. Cl. G06F 16/901; G06F 9/451

(52) U.S. Cl. CPC G06F 16/9024; G06F 9/451

(57) ABSTRACT

The present disclosure provides a method and an apparatus for editing a node-edge graph, a computing device, a computer storage medium and a computer program product. The method includes: receiving, in a view of the node-edge graph, a marking operation for at least one node in the node-edge graph; determining at least one edge associated with the at least one marked node; and displaying the at least one node and the at least one edge in a highlighted manner.

### CROSS-REFERENCE TO RELATED APPLICATIONS

This application claims priority to PCT Application No. PCT/CN2025/083581 filed on March 19, 2025, the disclosure of which is incorporated herein by reference in its entirety.

### FIELD

The present disclosure relates to the technical field of computers, and more specifically, to a method and an apparatus for editing a node-edge graph, a computing device, a computer storage medium and a computer program product.

### BACKGROUND

A node-edge graph (also referred to as a graph structure) consists of nodes and edges. The nodes are used to represent various entities, and the edges are used to describe associations among the nodes. The node-edge graph, as a common data visualization tool, is widely applied to present and analyze complex data relationships, which can directly display the associations between data using the topological structure of nodes and edges.

### SUMMARY

Embodiments of the present disclosure provide a method and an apparatus for editing a node-edge graph, a computing device, a computer storage medium and a computer program product.

In a first aspect of the present disclosure, there is provided a method for editing a node-edge graph, comprising: receiving, in a view of the node-edge graph, a marking operation for at least one node in the node-edge graph; determining at least one edge associated with the at least one marked node; and displaying the at least one node and the at least one edge in a highlighted manner.

In a second aspect of the present disclosure, there is provided an apparatus for editing a node-edge graph, comprising: a receiving unit configured to receive, in a view of the node-edge graph, a marking operation for at least one node in the node-edge graph; a determining unit configured to determine at least one edge associated with the at least one marked node; and a displaying unit configured to display the at least one node and the at least one edge in a highlight manner.

In a third aspect of the present disclosure, there is provided a computing device, comprising: at least one processing unit; and at least one memory coupled to the at least one processing unit and storing instructions executable by the at least one processing unit, wherein the instructions, when executed by the at least one processing unit, cause the computing device to perform the method in the first aspect of the present disclosure.

In a fourth aspect of the present disclosure, there is provided a non-transitory computer storage medium, comprising machine-executable instructions that, when executed by a device, cause the device to perform the method in the first aspect of the present disclosure.

In a fifth aspect of the present disclosure, there is provided a computer program product comprising machine-executable instructions that, when executed by a device, cause the device to perform the method in the first aspect of the present disclosure.

It would be appreciated that the Summary is not intended to identify key features or essential features of the present disclosure, nor is it intended to be used to limit the scope of the present disclosure. Other features of the present disclosure will be made apparent through the following description.

### BRIEF DESCRIPTION OF THE DRAWINGS

With reference to the following detailed description of the accompanying drawings, the above and other objectives, features, and advantages of the embodiments of the present disclosure will be made clearer. In the drawings, multiple embodiments of the present disclosure are depicted in an exemplary, but non-limiting, manner, where:

FIG. 1 illustrates a schematic flowchart of a method for editing a node-edge graph according to embodiments of the present disclosure;

FIG. 2 illustrates a schematic diagram of a view of nodes and edges marked based on a first editing mode according to embodiments of the present disclosure;

FIG. 3 illustrates a schematic diagram of a view of nodes and edges marked based on a second editing mode according to embodiments of the present disclosure;

FIG. 4 illustrates a schematic diagram of a view, in which highlighting effect of marked nodes and edges is displayed, according to embodiments of the present disclosure;

FIG. 5 illustrates a schematic diagram of a view, in which highlighting effect of marked nodes and edges is concealed, according to embodiments of the present disclosure;

FIG. 6 illustrates a schematic diagram of a shared view, in which marked nodes and edges are displayed, according to embodiments of the present disclosure;

FIG. 7 illustrates a block diagram of an apparatus for editing a node-edge graph according to embodiments of the present disclosure; and

FIG. 8 illustrates a block diagram of an electronic device according to embodiments of the present disclosure.

Throughout the drawings, the same or similar reference numerals represent the same or similar elements.

### DETAILED DESCRIPTION OF EMBODIMENTS

Reference below will be made to describe the embodiments of the present disclosure in detail. Although some embodiments of the present disclosure are depicted in the drawings, it would be appreciated that the present disclosure could be implemented in various forms and should not be construed as being restricted to the embodiments described herein. Rather, those embodiments are provided to enable a more thorough and complete understanding of the present disclosure. It is to be understood that the drawings and embodiments of the present disclosure are provided only exemplarily, but not used to limit the protection scope of the present disclosure.

As described herein, the term “includes” or similar expressions are to be read as open-ended terms that mean “includes, but is not limited to.” The term “based on” is to be read as “based at least in part on.” The term “an embodiment” or “the embodiment” is to be read as “at least one embodiment.” The terms “first,” “second,” and the like may refer to different objects or the same object unless explicitly indicated otherwise. Other definitions, explicit and implicit, may be included below.

Hereinafter, reference will be made to the drawings to describe the basic principle and implementations of the present disclosure. It would be appreciated that the example embodiments are provided only to enable those skilled in the art to better understand and further carry out the embodiments of the present disclosure, rather than suggest any limitation to the scope of the present disclosure.

According to the existing node-edge graph technology, when a user wants to emphasize a specific node or edge of a graph, the user can only use a screenshot function of a third-party tool (e.g. drawing software) to mark the node or edge. Such operation is cumbersome, and the generated marked content cannot be dynamically associated with the original view, resulting in low efficiency in recording and viewing. In addition, the marked content generated through a screenshot cannot be directly modified in or removed from the original view. If the markings are to be adjusted, the user needs to repeat the screenshot and drawing steps, which greatly increases the complexity of the operation and affects the user experience.

To this end, the present disclosure provides a method for editing a node-edge graph. According to the method, in a view including a node-edge graph, a marking operation for one or more nodes in the node-edge graph can be received. Based on the marking operation for the one or more nodes, one or more edges associated with the one or more marked nodes are determined. In the view, the one or more marked nodes and the one or more associated edges are highlighted.

With the method, the nodes can be directly marked in the view of the node-edge graph, and the marked nodes and edges associated with the nodes can be highlighted in the view, enabling a user to perform drawing and marking operations without using the screenshot function, which can reduce the complexity of the marking operation while improving the convenience for the user to mark and view the node-edge graph.

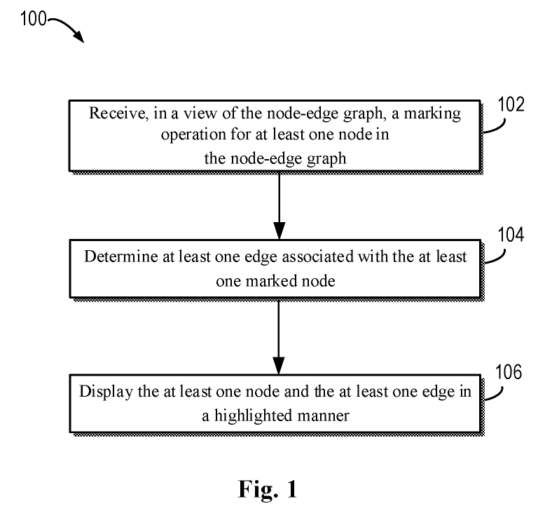

FIG. 1 illustrates a schematic flowchart of a method 100 for editing a node-edge graph according to embodiments of the present disclosure. The method can be implemented by any electronic device with computing and display capabilities, including, but not limited to, a mobile phone, a tablet, a wearable device, an on-vehicle device, an augmented reality/virtual reality device, a laptop computer, an ultra-mobile personal computer, a netbook computer, a personal digital assistant, an IoT device, an industrial terminal, and other electronic device with an interface display function. The specific type of the electronic device is not limited herein.

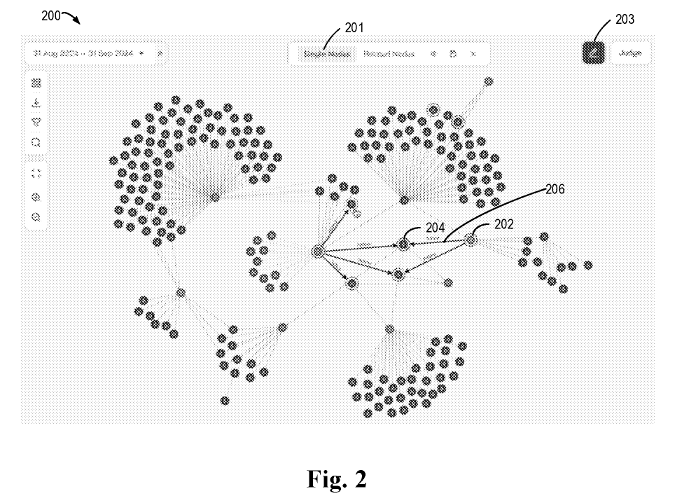

In the method 100 as shown in FIG. 1, in block 102, a marking operation for at least one node in the node-edge graph is received in a view of the node-edge graph. The marked node is a node of interest that a user intends to highlight. In some embodiments, the user can click an edit button (e.g. the button 203 in FIG. 2) in the view and then perform the marking operation on the node.

In some embodiments, in the view having a node-edge graph displayed therein, a marking operation performed on at least one node in the node-edge graph is received. By way of example, for a node-edge graph displayed in a visual form, the user can mark one or more nodes in the graph through interactive means provided in the view. Upon obtaining a marking instruction for a node in the view of the node-edge graph issued by the user through an input device (e.g. an operation of clicking a mouse, touching a screen, or the like), the marking action is completed for the corresponding node in the view, and the marking status is recorded and presented on the screen of the device.

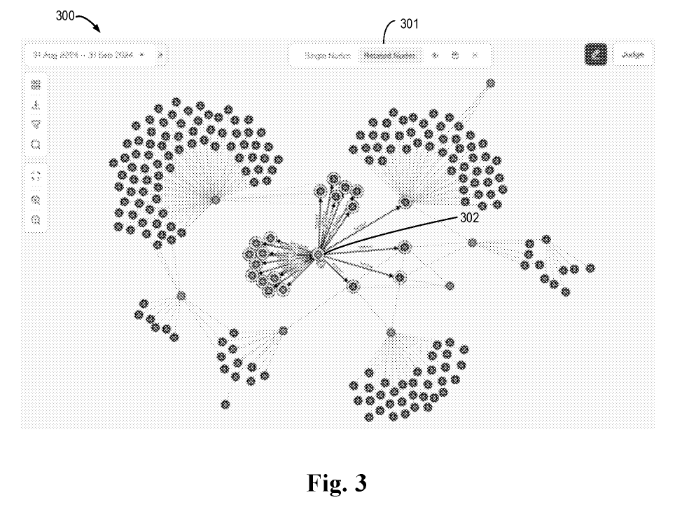

In block 104, at least one edge associated with the at least one marked node is determined. In order to display the relationships between marked node and other nodes, some edges connected to the marked node can also be highlighted. The embodiments of the present disclosure provide two different modes for automatically selecting an edge to be highlighted, without requiring any user operation, which will be described below with reference to FIGS. 2 and 3.

In some embodiments, in the view having the node-edge graph displayed therein, based on the obtained marking operation on one or more nodes, one or more edges directly associated with the one or more marked nodes are determined to be displayed in a highlighted manner. Specifically, the device can traverse the data structure of the entire node-edge graph, and identify an edge connected to the marked node by comparing identifier information of the node and the corresponding relationship between the start node and the end node connected with the edge, so as to accurately determine and filter out the edge associated with the marked node. The edge associated with the marked node can be selected based on a single-node mode (i.e., a first editing mode herein) or a related-node mode (i.e., a second editing mode herein).

FIG. 2 illustrates a schematic diagram of a view of nodes and edges marked based on a first editing mode according to embodiments of the present disclosure. As shown therein, the view 200 displayed on a screen of a device may include a node 202, a node 204 and an edge connected to the node 202 and the node 204.

In some embodiments, when a node-edge graph in a view is being edited, the first editing mode is determined as the editing mode. A selection on the editing mode is received. For example, by clicking a mode button 201, it is determined that the editing mode is the first editing mode. In the first editing mode, an edge with both endpoint nodes marked is determined as the edge to be highlighted. Referring to FIG. 2, when the node 202 and the node 204 are marked, the edge 206 connected to the node 202 and the node 204 is determined as the edge to be highlighted. If only the node 202 or the node 204 is marked, the edge 206 will not be determined as the edge to be highlighted.

FIG. 3 illustrates a schematic diagram of a view of nodes and edges marked based on a second editing mode according to embodiments of the present disclosure. As shown therein, the view 300 displayed on a screen of a device may include a node 302.

In some embodiments, when a node-edge graph in a view is being edited, a selection on the editing mode is received. For example, by clicking a mode button 301, it is determined that the current editing mode is the second editing mode. In the second editing mode, a marking operation on the node 302 is received, and edges connected to the node 302 are all determined to be highlighted. In some embodiments, nodes directly connected to the node 302 can also be marked automatically.

In block 106, at least one node and at least one edge are highlighted.

In some implementations, in the view having the node-edge graph displayed therein, after the marking operation on the one or more nodes in the node-edge graph has been obtained, one or more edges associated with the one or more marked nodes are determined, to thus obtain a set of nodes and a set of edges to be highlighted. The device can highlight those nodes and edges. By way of example, the display effect of the marked nodes and the associated edges in the view can be changed using color, brightness or other visual highlighting method, to significantly distinguish those nodes and edges from other unmarked elements in the entire node-edge graph, and thus allow the user to directly and clearly identify associations between the specific nodes and edges.

In some embodiments, referring to FIG. 2, in the first editing mode, the marked nodes, for example, the nodes 202 and 204, are highlighted. When the node 202 and the node 204 are both marked, the edge 206 connecting the node 202 with the node 204 is highlighted, and the name of the edge 206 is displayed close to the edge 206, where the name indicates a relationship between the node 202 and the node 204 at two endpoints of the edge 206. It would be appreciated that the description about highlighting the marked nodes and edges is provided only as an example, and the view 200 may include more or fewer highlighted marked nodes and edges, which is not limited herein.

In some embodiments, referring to FIG. 3, in the second editing mode, the marked nodes and edges connected thereto are highlighted. By way of example, the node 302 and nodes connected thereto are highlighted in the view 300 of the node-edge graph. In the case of determining the marked node 302, a plurality of edges connected to the node 302 are highlighted, and names corresponding to the respective edges are displayed close to the respective edges. It would be appreciated that the description about highlighting the marked node, and the nodes and the edges connected to the marked node, is provided only as an example, and the view 300 may include more or fewer highlighted marked nodes and edges, which is not limited herein.

In this way, in a view of a node-edge graph, a marked node and an edge associated with the marked node can be determined and highlighted, such that a user can directly perform an editing operation on prominent elements, such as the node and the edge, in the node-edge graph. Therefore, the present disclosure can solve the problem in the existing technology that a node and an edge cannot be directly marked in a node-edge graph, and improve the convenience of editing the node-edge graph.

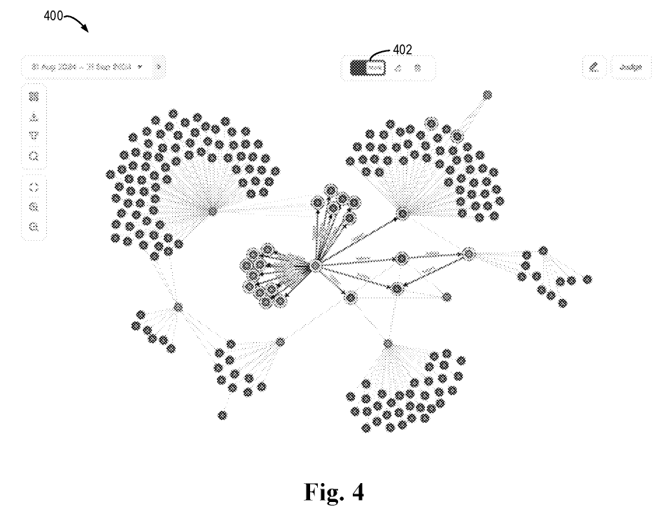

FIG. 4 illustrates a schematic diagram of a view 400, in which highlighting effect of marked nodes and edges is displayed, according to embodiments of the present disclosure. The view 400 includes a toggle control 402 used for determining whether a marked node and an edge are to be highlighted. As shown therein, a selection on a state of the toggle control 402 is received, and it is determined that the toggle control 402 is in a first state where highlighting is allowed. When the toggle control 402 is in the first state, one or more marked nodes and edges associated with the nodes included in the view 400 are highlighted.

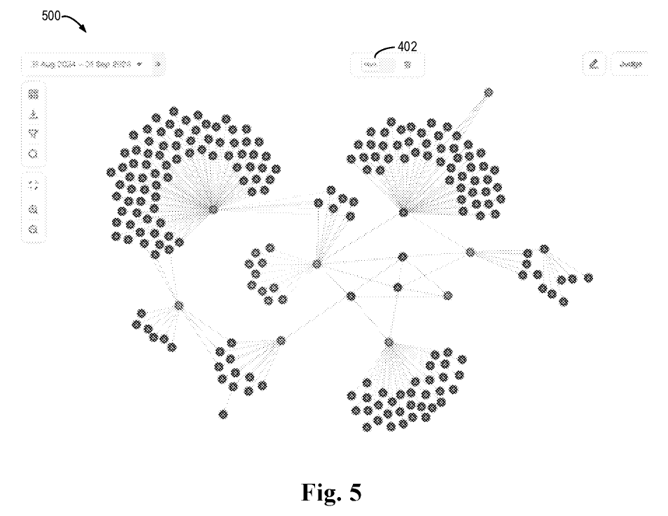

FIG. 5 illustrates a schematic diagram of a view 500, in which highlighting effect of marked nodes and edges is concealed, according to embodiments of the present disclosure. The view 500 includes a toggle control 402. As shown therein, a selection on a state of the toggle control 402 is received, and it is determined that the toggle control 402 is in a second state where highlighting is stopped. When the toggle control 402 is in the second state, the highlighting effect of the marked nodes and the edges associated with the nodes in the view 500 is concealed. When the toggle control 402 is toggled to the first state, the view displayed on the screen is switched back to the view 400. With the method, the present disclosure can flexibly determine whether highlighting effect is displayed in a view according to the user needs, attaining more diversified and more flexible display effect.

In some embodiments, the view may further include a marking clear control. In response to the marking clear control being triggered, all markings in the view are cleared. By way of example, reference will be made to FIGS. 2 or 3. An operation of clearing markings in the view is received, and the marking clear control is triggered. When the marking clear control is triggered, the markings are cleared from all the highlighted marked nodes and all the highlighted edges in the view 200 or 200, and the highlighting effect is not displayed any longer.

In some embodiments, in response to removal of a marking of a node among the at least one node, highlighting effect of the node and an edge connected to the node is cleared. By way of example, referring to FIG. 2, when the marking of the node 202 is removed, the highlighting effect of the node 202, as well as the edge 206 and another edge at the lower left part of the node 202 connected to the node 202, is cleared; when the marking of the node 204 is removed, the highlighting effect of the node 204, as well as the edge 206 and another edge at the lower left part of the node 204 connected to the node 204, is cleared. By way of example, referring to FIG. 3, when the marking of the node 302 is removed, the highlighting effect of the node 302 and all the edges connected to the node 302 is cleared.

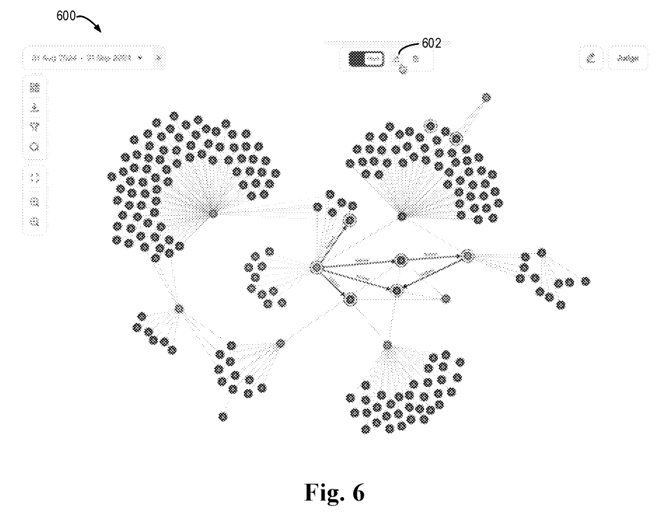

FIG. 6 illustrates a schematic diagram of a shared view 600, in which marked nodes and edges are displayed, according to embodiments of the present disclosure. The view 600 may include a share control 602 for sharing the view 600.

As shown therein, an interactive operation on the share control 602 is received, and when the shared control 602 is triggered, a link of the view 600 is copied. This link follows a specific URL (Uniform Resource Locator) format specification, which contains sufficient parameter information such that the current view 600 can be accurately restored in the future through the link. Having been copied, the link of the view is sent to the internet, for example, to be shared with other users.

In some embodiments, other users can obtain the shared link from the network. The shared view is displayed based on the shared link, where the shared view includes the node-edge graph with the highlighted nodes and edges. It would be appreciated that the current user device can also obtain the edited views shared by other users. By way of example, the device can obtain the shared link from the network, and parse the link to extract parameter information related to the view of the node-edge graph, for example, data identifiers of nodes and edges, highlighting effect information, and the like. The shared view is generated and displayed based on the obtained parameter information. On the basis, the user can further edit the node-edge graph, to thus achieve collaborative editing among users.

With the method, a user can share an edited view, and other users can perform an editing operation on the shared view, to thus achieve collaborative editing among multiple users and improve the collaborative editing capability for node-edge graphs.

The example embodiments described above with reference to FIGS. 1-6 provide a method for editing a node-edge graph. As compared with the prior art, the method has the following advantage: a marking operation can be directly performed on a node in a view of a node-edge graph, and the marked node and an edge associated with the node can be highlighted in the view, enabling a user to perform drawing and marking operations without using the screenshot function, which can reduce the complexity of the marking operation while improving the convenience for the user to mark and view the node-edge graph. In addition, the user can remove or clear markings as required, and share the view of the edited node-edge graph with other users, which can greatly optimize the interactive experience.

FIG. 7 illustrates a schematic block diagram of an apparatus 700 for editing a node-edge graph according to embodiments of the present disclosure. The apparatus 700 can be used to implement the method or steps described with reference to FIGS. 1-6.

As shown therein, the apparatus 700 includes a receiving unit 702, a determining unit 704 and a displaying unit 706. The receiving unit 702 is configured to receive, in a view of the node-edge graph, a marking operation for at least one node in the node-edge graph. The determining unit 704 is configured to determine at least one edge associated with the at least one marked node. The displaying unit 706 is configured to display the at least one node and the at least one edge in a highlight manner.

In some embodiments, the determining unit 704 can be configured to: determine a first editing mode for the node-edge graph; and determine, in the first editing mode, that edges with both endpoints marked are to be highlighted.

In some embodiments, the determining unit 704 can be configured to: determine a second editing mode for the node-edge graph; and determine, in the second editing mode, that edges connected to the at least one node are to be highlighted.

In some embodiments, the determining unit 704 can be configured to: display nodes in the highlighted manner that are connected to the at least one node.

In some embodiments, the displaying unit 706 can be configured to: display a name of the at least one edge, where the name indicates a relationship between nodes at two endpoints of the at least one edge.

In some embodiments, the apparatus 700 can also be configured to: in response to removal of a marking of a node among the at least one node, clear highlighting effect of the node and an edge connected to the node.

In some embodiments, the view comprises a marking clear control, and the apparatus 700 can also be configured to: in response to the marking clear control being triggered, clear markings in the view.

In some embodiments, the view comprises a toggle control, and the apparatus 700 can also be configured to: in response to the toggle control being in a first state, display the at least one node and the at least one edge in the highlighted manner; and in response to the toggle control being in a second state, conceal the highlighting effect of the at least one node and the at least one edge.

In some embodiments, the view comprises a share control, and the apparatus 700 can also be configured to: in response to the share control being triggered, copy a link of the view; and send the link to a network.

In some embodiments, the apparatus 700 can also be configured to: obtain a shared link from the network; and display a shared view based on the shared link, the shared view including a node-edge graph with highlighted nodes and edges.

It is worth noting that more actions or steps as shown in FIGS. 1-6 can be implemented by the apparatus 700 as shown in FIG. 7. For example, the apparatus 700 may include more modules or units to implement the actions or steps described above, or some units or modules shown in FIG. 7 can be further configured to implement the actions or steps described above. Details are omitted here for brevity.

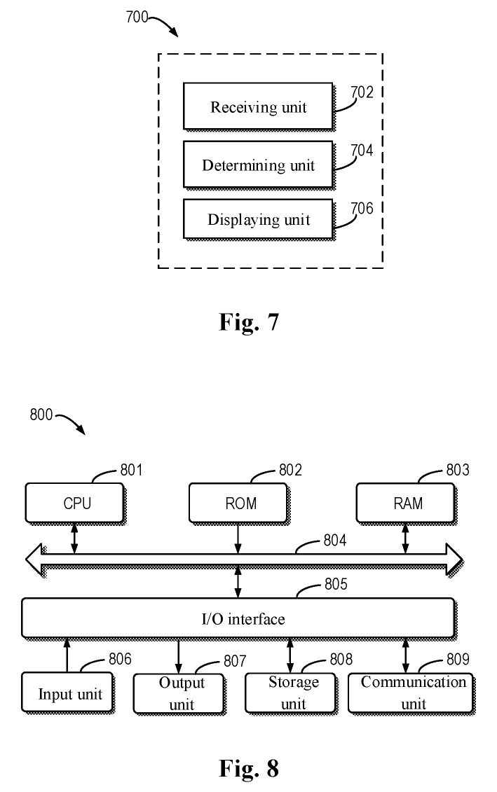

FIG. 8 illustrates an example block diagram of an example device 800 that can implement embodiments of the present disclosure. As shown therein, the device 800 may include a computing unit 801 which can execute various actions and processing based on programs stored in a Read Only Memory (ROM) 802 or a program loaded from a storage unit 806 to a Random Access Memory (RAM) 803. RAM 803 stores therein various programs and data required for operations of the device 800. The computing unit 801, the ROM 802, and the RAM 803 are connected to one another via a bus 804. An input/output (I/O) interface 805 is also connected to the bus 804.

A plurality of components in the device 800 may be connected to the I/O interface 805, including: an input unit 806 including, for example, a keyboard, a mouse, and the like; an output unit 807 including various types of displays, loudspeakers, and the like; a storage unit 808 including, for example, a magnetic disk, a compact disc, or the like; and a communication unit 809, for example, a network card, a modem, a wireless communication transceiver, or the like. The communication unit 809 can allow the device 800 to exchange information/data with other devices through a computer network such as Internet, and/or various kinds of telecommunication networks.

The computing unit 801 may be various types of general purpose and/or specific purpose processing components having a processing and computing capability. Some examples of the computing unit 801 include, but are not limited to, a Central Processing Unit (CPU), a Graphics Processing Unit (GPU), various types of specific-purpose Artificial Intelligence (AI) computing chips, various types of computing units having machine learning model algorithms run thereon, a Digital Signal Processor (DSP), any appropriate processor, controller, microcontroller, or the like. The computing unit 801 can execute various methods and processing described above, for example, the method 100. For example, the method 100 may be implemented as computer software programs that are tangibly included in a machine readable medium, e.g., the storage unit 808. In some embodiments, part or all of the computer programs may be loaded and/or mounted onto the device 800 via ROM 802 and/or communication unit 809. When the computer program is loaded to the RAM 803 and executed by the computing unit 801, one or more steps of the method 100 as described above can be executed. Alternatively, in other embodiments, the computing unit 801 may be configured in any other appropriate manners (for example, by means of firmware) to perform the method 100.

In some embodiments, the method and process described above may be implemented as a computer program product. The computer program product may include a computer readable storage medium having stored thereon computer readable program instructions for performing various aspects of the present disclosure.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a Random Access Memory (RAM), a Read-Only Memory (ROM), an Erasable Programmable Read-Only Memory (EPROM or Flash memory), a Static Random Access Memory (SRAM), a portable Compact Disc Read-Only Memory (CD-ROM), a Digital Versatile Disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals sent through a wire.

Computer readable program instructions described herein can be downloaded to corresponding computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the corresponding computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a Local Area Network (LAN) or a Wide Area Network (WAN), or the connection may be made to an external computer (for example, through the Internet using an Internet Service Provider). In some embodiments, electronic circuitry including, for example, programmable logic circuitry, Field-Programmable Gate Arrays (FPGAs), or Programmable Logic Arrays (PLAs) may execute the computer readable program instructions by utilizing state information of the computer readable program instructions to personalize the electronic circuitry, in order to perform aspects of the present disclosure.

These computer readable program instructions may be provided to a processing unit of a general purpose computer, special purpose computer, or other programmable data processing device to produce a machine, such that the instructions, when executed via the processing unit of the computer or other programmable data processing device, create apparatuses for implementing the functions/actions specified in the flowchart and/or block diagram block or blocks. These computer readable program instructions may also be stored in a computer readable storage medium that can direct a computer, a programmable data processing device, and/or other devices to function in a particular manner, such that the computer readable storage medium having instructions stored thereon includes an article of manufacture including instructions which implement aspects of the functions/actions specified in the flowchart and/or block diagram block or blocks.

The computer readable program instructions may also be loaded onto a computer, other programmable data processing devices, or other devices to cause a series of operational steps to be performed on the computer, other programmable devices or other devices to produce a computer implemented process, such that the instructions which are executed on the computer, other programmable devices, or other devices implement the functions/actions specified in the flowchart and/or block diagram block or blocks.

The flowchart and block diagrams illustrate the architecture, functionality, and operation of possible implementations of systems, methods and computer program products according to various embodiments of the present disclosure. In this regard, each block in the flowchart or block diagrams may represent a module, snippet, or portion of code, which includes one or more executable instructions for implementing the specified logical function(s). In some alternative implementations, the functions noted in the block may occur out of the order noted in the images. For example, two blocks in succession may, in fact, be executed substantially concurrently, or the blocks may sometimes be executed in the reversed order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or actions, or combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

We claim:

1. A method for editing a node-edge graph, comprising:
receiving, in a view of the node-edge graph, a marking operation for at least one node in the node-edge graph;
determining at least one edge associated with the at least one marked node; and
displaying the at least one node and the at least one edge in a highlighted manner.

2. The method of claim 1, wherein determining the at least one edge associated with the at least one marked node comprises:
determining a first editing mode for the node-edge graph; and
determining, in the first editing mode, that edges with both endpoints marked are to be highlighted.

3. The method of claim 1, wherein determining the at least one edge associated with the at least one marked node comprises:
determining a second editing mode for the node-edge graph; and
determining, in the second editing mode, that edges connected to the at least one node are to be highlighted.

4. The method of claim 3, further comprising:
displaying nodes in the highlighted manner that are connected to the at least one node.

5. The method of claim 1, wherein displaying the at least one node and the at least one edge in the highlighted manner comprises:
displaying a name of the at least one edge, the name indicating a relationship between nodes at two endpoints of the at least one edge.

6. The method of claim 1, further comprising:
in response to removal of a marking of a node among the at least one node, clearing a highlighting effect of the node and an edge connected to the node.

7. The method of claim 1, wherein the view comprises a marking clear control, and the method further comprises:
in response to the marking clear control being triggered, clearing markings in the view.

8. The method of claim 1, wherein the view comprises a toggle control, and the method further comprises:
in response to the toggle control being in a first state, displaying the at least one node and the at least one edge in the highlighted manner; and
in response to the toggle control being in a second state, concealing a highlighting effect of the at least one node and the at least one edge.

9. The method of claim 1, wherein the view comprises a share control, and the method further comprises:
in response to the share control being triggered, copying a link of the view; and
sending the link to a network.

10. The method of claim 9, further comprising:
obtaining a shared link from the network; and
displaying a shared view based on the shared link, the shared view including a node-edge graph with highlighted nodes and edges.

11. A device, comprising:
at least one processing unit; and
at least one memory coupled to the at least one processing unit and storing instructions executable by the at least one processing unit, wherein the instructions, when executed by the at least one processing unit, cause the device to perform a method comprising:
receiving, in a view of a node-edge graph, a marking operation for at least one node in the node-edge graph;
determining at least one edge associated with the at least one marked node; and
displaying the at least one node and the at least one edge in a highlighted manner.

12. The device of claim 11, wherein determining the at least one edge associated with the at least one marked node comprises:
determining a first editing mode for the node-edge graph; and
determining, in the first editing mode, that edges with both endpoints marked are to be highlighted.

13. The device of claim 11, wherein determining the at least one edge associated with the at least one marked node comprises:
determining a second editing mode for the node-edge graph; and
determining, in the second editing mode, that edges connected to the at least one node are to be highlighted.

14. The device of claim 13, the method further comprising:
displaying nodes in the highlighted manner that are connected to the at least one node.

15. The device of claim 11, wherein displaying the at least one node and the at least one edge in the highlighted manner comprises:
displaying a name of the at least one edge, the name indicating a relationship between nodes at two endpoints of the at least one edge.

16. The device of claim 11, the method further comprising:
in response to removal of a marking of a node among the at least one node, clearing a highlighting effect of the node and an edge connected to the node.

17. The device of claim 11, wherein the view comprises a marking clear control, and the method further comprises:
in response to the marking clear control being triggered, clearing markings in the view.

18. The device of claim 11, wherein the view comprises a toggle control, and the method further comprises:
in response to the toggle control being in a first state, displaying the at least one node and the at least one edge in the highlighted manner; and
in response to the toggle control being in a second state, concealing a highlighting effect of the at least one node and the at least one edge.

19. The device of claim 11, wherein the view comprises a share control, and the method further comprises:
in response to the share control being triggered, copying a link of the view; and
sending the link to a network.

20. A non-transitory computer storage medium comprising machine-executable instructions that, when executed by a device, cause the device to perform a method comprising:
receiving, in a view of a node-edge graph, a marking operation for at least one node in the node-edge graph;
determining at least one edge associated with the at least one marked node; and
displaying the at least one node and the at least one edge in a highlighted manner.
